(19) United States
(12) Patent Application Publication
(10) Pub. No.: US 2002/0016754 A1
(43) Pub. Date: Feb. 7, 2002

(54) System, method, and article of manufacture for conducting a transaction on any site on the world wide web on behalf of a user from any device

(76) Inventors: Umair A. Khan, Fremont, CA (US); Salman Akhtar, Fremont, CA (US); Wasiq M. Bokhari, Fremont, CA (US)

Correspondence Address: SILICON VALLEY INTELLECTUAL PROPERTY GROUP, P.O. BOX 721120, SAN JOSE, CA, 95172-1120, US

(21) Appl. No.: 09/882,541

(22) Filed: Jun. 15, 2001

Related U.S. Application Data
(60) Provisional application No. 60/212,485, filed on Jun. 16, 2000.

(51) Int. Cl. G06F 17/60

(52) U.S. Cl. 705/35; 705/26

(57) ABSTRACT

Accordingly, a system, method and article of manufacture are provided for conducting a transaction on a website without requiring a user to submit personal information. Information about a user is stored in a database located remotely from the user. A request from the user for purchase of product(s) and/or service(s) on a website is received. A purchase pattern of the website is retrieved such as from a database of stored purchase patterns that have been determined for various websites. The product(s) and/or service(s) on the website are purchased on behalf of the user based on the purchase pattern. A system, method and article of manufacture are also provided for an account aggregation tool for determining a transaction pattern of a website. A website is identified. The types of user information required on a user information page or pages for purchase of at least one of a product and a service is determined. Also, the user information page or pages is identified. The types of information required is associated with fields of the information page where the information would be entered or selected by the user. The types of information, an identification of the information page or pages, and the associations of the types of information and the fields are stored.

### FIELD OF THE INVENTION

The present invention relates to financial transactions and more particularly to conducting transactions on behalf of a user from a centralized location such that the user does not have to repeatedly input personal information for different websites. The transactions may be initiated and conducted from any device.

### BACKGROUND OF THE INVENTION

E-commerce, or conduction of web-based financial transactions, is one of the greatest revenue and traffic generators on the web. However, there are significant bottlenecks to the growth of E-commerce.

A user who wishes to conduct a financial transaction on a particular site must submit personal information either at every transaction or at least at one time, including but not restricted to, credit card number(s), shipping information and contact telephone number(s). For example, Amazon.com has a “1-click buy” concept that utilizes stored user information, but applies only to transactions on Amazon.com. If the user wishes to conduct a financial transaction at a different site, the personal information has to be submitted again. This results in a significant effect on the user's experience. If, for example, a user has already stored his/her personal information at site A, then the user will be reluctant to submit it again for site B. If site B is considered to be less “trustworthy” than site A, the user will not use it even if he/she can get a better deal at it.

If a business-enabling site wishes to allow its users to conduct transactions at different sites without having them enter their personal information at every site, they need to have partnerships with the other sites. These partnerships involve a definition of the information required by the site to conduct the transactions. This introduces a serious bottleneck in the growth of e-commerce on the web since the establishment of partnerships is a slow process. Moreover, the expansion of e-commerce through partnerships further establishes the domination of the established players due their existing user and partner base.

The current paradigm for payment over the web is through credit cards. Fully fifty percent of eligible adults in the U.S do not possess credit cards. Outside the U.S, this fraction is even higher. As a result, a large number of people who are financially capable of purchasing goods over the internet cannot do so.

Currently most of the e-commerce happens over the desktops or wired devices. Wireless web connection will explode over the coming years. Wireless e-commerce is quite primitive currently; as a result it does not have any acceptance. The bottleneck in wireless transactions is that the creation of wireless versions of transactions sites is not easy, and as a result it has only been done for small sections of a handful of sites. The bulk of e-commerce stays on the wired devices. Consequently, there are few compelling mobile commerce sources available to consumers and the available sources of mobile commerce provide a limited ability to effectively conduct transactions from mobile devices.

Security is a big concern in transactions. Many users are hesitant to send personal information such as names, addresses, credit card information, etc. across the network.

Thus, what is needed is a way to allow any user to conduct a transaction (financial or otherwise) on any site on the web, without having to submit his personal information (like credit card number etc.).

### SUMMARY OF THE INVENTION

Embodiments of the present invention allow any user to conduct a transaction (financial or otherwise) on any site on the web, without having to submit his or her personal information (like credit card number etc.). Thus, the user is allowed to instantaneously conduct a transaction from any site in the world and from any device, wired or wireless, whether it is a buy/sell/compare transaction in the B2C market, a supply chain transaction in the B2B market or a complicated e-procurement deal in the B2E market. In addition, these transactions may be conducted from any device, including, but not limited to PC's, mobile phones, PDA's, ordinary voice phones, desktop computers, or any device, wired or wirelss.

Accordingly, a system, method and article of manufacture are provided for conducting a transaction on a website without requiring a user to submit personal information. Information about a user is stored in a database located remotely from the user. A request from the user for purchase of product(s) and/or service(s) on a website is received. A purchase pattern of the website is retrieved such as from a database of stored purchase patterns that have been determined for various websites. The product(s) and/or service(s) on the website are purchased on behalf of the user based on the purchase pattern.

In one aspect of the present invention, the purchase pattern includes a sequence of data required, identification of web pages presented, and actions required during a purchase transaction. In a preferred embodiment of the present invention, an identification of the website and an identifier of the product(s) and/or service(s) are made. The purchasing of the product(s) and/or service(s) further includes recreating a purchase transaction on the website utilizing the user information, the identification of the website, and the identifier of the product(s) and/or service(s).

In another aspect of the present invention, the product(s) and/or service(s) are purchased such that the user remains anonymous. In a further aspect of the present invention, the user can make the request from at least one of a wireless device and a hardwired device. Preferably, the user can send the request for purchase by a single selection of an item on a user interface of the user. For example, the user can, with the press of a single button buy the item.

A further aspect of the present invention is that it enables the initiation, conduction and fulfillment of any internet based transaction from any device, wired or wireless. Examples of such wireless devises include a wireless telephone, Personal Digital Assistant (PDA), handheld computer such as a handheld PC, a pager, a device connected to a wireless modem, or any type of device capable of receiving information where at least one of the communication links is wireless. Examples of such wired devices include desktop and laptop computers connected to an internet, telephones, etc.

A system, method and article of manufacture are also provided for an account aggregation tool for determining a transaction pattern of a website. A website is identified. The types of user information required on a user information page or pages for purchase of at least one of a product and a service is determined. Also, the user information page or pages is identified. The types of information required is associated with fields of the information page where the information would be entered or selected by the user. It should be noted that fields can mean any mechanism for entering user information, including but not limited to, fields where information is typed, tables from which information can be selected, and drop down menus, etc. The types of information, an identification of the information page or pages, and the associations of the types of information and the fields are stored.

In an aspect of the present invention, a manner in which the user information is sent to the website is also recorded. This can include the type of communication protocol utilized, a format of the information, and whether the information is sent using a security protocol.

In yet another aspect of the present invention, users can get the best deals they can get because they are now not limited to certain big sites. By soliciting the services of external financial and risk-management businesses, the implementor of the present invention can cover any risk that might be involved in dealing with smaller sites that are perceived to be less “trustworthy”.

A further aspect of the present invention enables users to conduct transactions on any site. It does so on the basis of technology that allows any one to get any kind of content from any site and aggregate it one place. Such technology is described in copending US Patent Application entitled SYSTEM, METHOD AND ARTICLE OF MANUFACTURE FOR GENERATING A CUSTOMIZABLE NETWORK USER INTERFACE and filed Jun. 7, 2001 and assigned to common assignee, and which is incorporated herein by reference for all purposes. By aggregating the way transactions are conducted on any arbitrary site, the implementor of the present invention becomes the default e-commerce enabler of the web.

Another aspect of the present invention enables everyone to participate in e-commerce, even those without credit cards. To support payment in various forms, the services of other financial institutions can be solicited. For example, a bank can provide a direct debit to the user's checking, savings, or e-money account. Also, a credit agency could provide credit to the user, though the user does not have a credit card.

A further aspect of the present invention wireless enables any transaction site on the web. A description of technology that enables wireless delivery of content is found in copending US patent application entitled SYSTEM, METHOD, AND ARTICLE OF MANUFACTURE FOR WIRELESS ENABLEMENT OF THE WORLD WIDE WEB USING A WIRELESS GATEWAY filed Jun. 16, 2000 under Ser. No. 09/595,781 and which is incorporated herein by reference for all purposes.

A further aspect of the present invention is that it enables the initiation, conduction and fulfillment of any internet based transaction from any device, wired or wireless. Examples of such wireless devises include a wireless telephone, Personal Digital Assistant (PDA), handheld computer such as a handheld PC, a pager, a device connected to a wireless modem, or any type of device capable of receiving information where at least one of the communication links is wireless. Examples of such wired devices includes desktop and laptop computers connected to an internet, telephones, etc.

By using state of the art security protocols, a preferred embodiment of the present invention protects all the transactions of its users. In addition, it provides a unique form of protection to its users. Since the system of the present invention acts as an intermediary between the user and the destination site and can conduct the transaction on the user's behalf, the user's secure personal information is never transmitted across the network and therefore is never compromised. Only the financial information for the implementor of the present invention is used. The implementor of the present invention can reduce its own exposure by soliciting the services of an external risk-management business.

### BRIEF DESCRIPTION OF THE DRAWINGS

The invention will be better understood when consideration is given to the following detailed description thereof. Such description makes reference to the annexed drawings wherein:

FIG. 1 is a schematic diagram of a hardware implementation of one embodiment of the present invention;

FIG. 2 is a flowchart of a process for conducting a transaction on a website without requiring a user to submit personal information;

FIG. 3 is a flowchart depicting a process for an account aggregation tool for determining a transaction pattern of a website; and

FIG. 4 illustrates an exemplary system for navigating a network, including conducting transactions, in accordance with one embodiment of the present invention.

### DETAILED DESCRIPTION OF THE PREFERRED EMBODIMENTS

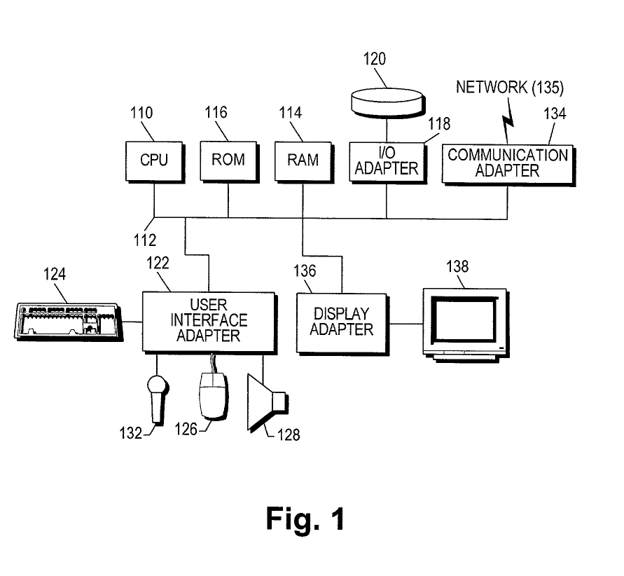

A preferred embodiment of a system in accordance with the present invention is preferably practiced in the context of a personal computer such as an IBM compatible personal computer, Apple Macintosh computer or UNIX based workstation. A representative hardware environment is depicted in FIG. 1, which illustrates a typical hardware configuration of a workstation in accordance with a preferred embodiment having a central processing unit 110, such as a microprocessor, and a number of other units interconnected via a system bus 112. The workstation shown in FIG. 1 includes a Random Access Memory (RAM) 114, Read Only Memory (ROM) 116, an I/O adapter 118 for connecting peripheral devices such as disk storage units 120 to the bus 112, a user interface adapter 122 for connecting a keyboard 124, a mouse 126, a speaker 128, a microphone 132, and/or other user interface devices such as a touch screen (not shown) to the bus 112, communication adapter 134 for connecting the workstation to a communication network (e.g., a data processing network) and a display adapter 136 for connecting the bus 112 to a display device 138. The workstation typically has resident thereon an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

The present invention may also be practiced in the context of a wireless device, such as a wireless telephone, Personal Digital Assistant (PDA), Personal Information Manager (PIM), handheld computer such as a handheld PC, a pager, a device connected to a wireless modem, etc. A description of wireless capabilities which may be used in conjunction with the present invention are described in copending US patent application entitled SYSTEM, METHOD AND ARTICLE OF MANUFACTURE FOR WIRELESS ENABLEMENT OF THE WORLD WIDE WEB USING A WIRELESS GATEWAY and filed Jun. 16, 2001 under Ser. No. 09/595,781, and which is incorporated herein by reference.

Various embodiments of the present invention allow any user to conduct a transaction (financial or otherwise) on any site on the web, without having to submit his personal information (like credit card number etc.). For example, the user just goes to any site of his choice, regardless of how well-known the site is, and if he finds the product he wishes to buy, he can, with the press of a single button buy the item. The key idea here is that the transaction can be conducted on any site on the web instantaneously without requiring repeated submission of personal information by the user. Another embodiment of the present invention allows a user to instantaneously conduct a transaction from any site in the world and from any device, wired or wireless, whether it is a buy/sell/compare transaction in the B2C market, a supply chain transaction in the B2B market or a complicated e-procurement deal in the B2E market.

Embodiments of the present invention allow any user to conduct a transaction (financial or otherwise) on any site on the web, without having to submit his or her personal information (like credit card number etc.). Thus, the user is allowed to instantaneously conduct a transaction from any site in the world and from any device, wired or wireless, whether it is a buy/sell/compare transaction in the B2C market, a supply chain transaction in the B2B market or a complicated e-procurement deal in the B2E market.

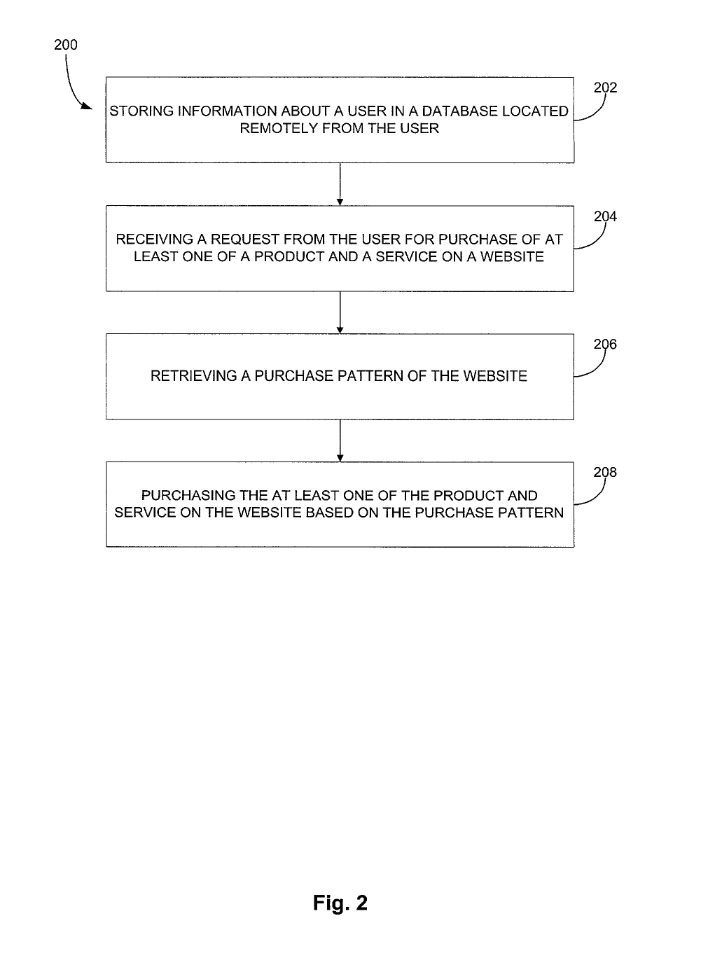

FIG. 2 is a flowchart of a process 200 for conducting a transaction on a website without requiring a user to submit personal information. In other words, the process allows for “frictionless transactions.” In operation 202, information about a user is stored in a database located remotely from the user. A request from the user for purchase of product(s) and/or service(s) on a website is received in operation 204. A purchase pattern of the website is retrieved in operation 206. The purchase pattern can be stored in a database of stored purchase patterns that have been determined for various websites. In operation 208, the product(s) and/or service(s) on the website are purchased on behalf of the user based on the purchase pattern.

A description of pattern replay and recording which may be used in conjunction with the present invention are described in Provisional US patent application entitled SYSTEM, METHOD AND COMPUTER PROGRAM PRODUCT FOR THE RECORDING AND PLAYBACK OF TRANSACTION MACROS and filed Apr. 12, 2001 under Ser. No. 60/283,781, and which is incorporated herein by reference.

In one embodiment of the present invention, the purchase pattern includes a sequence of data required, identification of web pages presented, and actions required during a purchase transaction. In a preferred embodiment of the present invention, an identification of the website and an identifier of the product(s) and/or service(s) are made. The purchasing of the product(s) and/or service(s) further includes recreating a purchase transaction on the website utilizing the user information, the identification of the website, and the identifier of the product(s) and/or service(s).

In another embodiment of the present invention, the product(s) and/or service(s) are purchased such that the user remains anonymous. In a further aspect of the present invention, the user can make the request from at least one of a wireless device and a hardwired device.

Another embodiment of the present invention enables the initiation, conduction and fulfillment of any internet based transaction from any device, wired or wireless. Examples of such wireless devises include a wireless telephone, Personal Digital Assistant (PDA), handheld computer such as a handheld PC, a pager, a device connected to a wireless modem, or any type of device capable of receiving information where at least one of the communication links is wireless. Examples of such wired devices include desktop and laptop computers connected to an internet, telephones, etc.

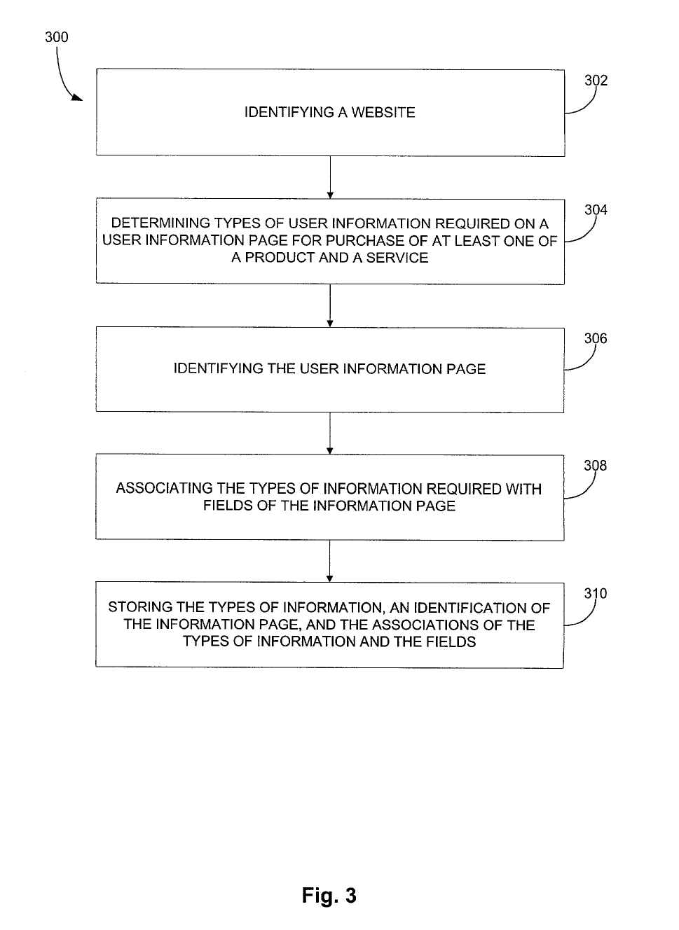

FIG. 3 is a flowchart depicting a process 300 for an account aggregation tool for determining a transaction pattern of a website. In operation 302, a website is identified. The types of user information required on a user information page or pages for purchase of at least one of a product and a service is determined in operation 304. Also, in operation 306, the user information page or pages is identified. In operation 308, the types of information required are associated with fields of the information page where the information is entered by the user. It should be noted that fields can mean any mechanism for entering user information, including but not limited to, fields where information is typed, tables from which information can be selected, and drop down menus, etc. The types of information, an identification of the information page or pages, and the associations of the types of information and the fields are stored in operation 310.

In an embodiment of the present invention, a manner in which the user information is sent to the website is also recorded. This can include the type of communication protocol utilized, a format of the information, and whether the information is sent using a security protocol.

In yet another embodiment of the present invention, users can get the best deals they can get because they are now not limited to certain big sites. By soliciting the services of external financial and risk-management businesses, the implementor of the present invention can cover any risk that might be involved in dealing with smaller sites that are perceived to be less “trustworthy”.

Another embodiment of the present invention enables the initiation, conduction and fulfillment of any internet based transaction from any device, wired or wireless. Examples of such wireless devises include a wireless telephone, Personal Digital Assistant (PDA), handheld computer such as a handheld PC, a pager, a device connected to a wireless modem, or any type of device capable of receiving information where at least one of the communication links is wireless. Examples of such wired devices includes desktop and laptop computers connected to an internet, telephones, etc.

A further embodiment of the present invention enables users to conduct transactions on any site. It does so on the basis of technology that allows any one to get any kind of content from any site and aggregate it one place. As mentioned above, such technology is described in copending US patent application entitled SYSTEM, METHOD AND ARTICLE OF MANUFACTURE FOR GENERATING A CUSTOMIZABLE NETWORK USER INTERFACE and filed Jun. 7, 2001 and assigned to common assignee, and which is incorporated herein by reference for all purposes. By aggregating the way transactions are conducted on any arbitrary site, the implementor of the present invention becomes the default e-commerce enabler of the web.

Another aspect of the present invention enables everyone to participate in e-commerce, even those without credit cards. To support payment in various forms, the services of other financial institutions can be solicited. For example, a bank can provide a direct debit to the user's checking, savings, or e-money account. Also, a credit agency could provide credit to the user, though the user does not have a credit card.

A further embodiment of the present invention wireless enables any transaction site on the web. A description of technology that enables wireless delivery of content is found in copending US patent application entitled SYSTEM, METHOD, AND ARTICLE OF MANUFACTURE FOR WIRELESS ENABLEMENT OF THE WORLD WIDE WEB USING A WIRELESS GATEWAY and filed Jun. 16, 2000 under Ser. No. 09/595,781, and which is incorporated herein by reference for all purposes.

By using state of the art security protocols, a preferred embodiment of the present invention protects all the transactions of its users. In addition, it provides a unique form of protection to its users. Since the system of the present invention acts as an intermediary between the user and the destination site and can conduct the transaction on the user's behalf, the user's secure personal information is never transmitted across the network and therefore is never compromised. Only the financial information for the implementor of the present invention is used. The implementor of the present invention can reduce its own exposure by soliciting the services of an external risk-management business.

The user experience for frictionless transactions according to one embodiment of the present invention is as follows: The user can surf the web in any way. When the user wishes to buy something from any site, he presses a “transact now” button which is resident on the user's desktop in some fashion. The transaction is immediately conducted without him having to enter any of his personal information. If the user has so configured his preferences, then every time he presses the “buy now” button, a dialog box can appear asking him whether he wants to conduct the transaction under his own name or anonymously.

Preferably, the user can select the “transact now” button to conduct any type of transaction (buy, sell, trade, etc.). The user can also choose to conduct a transaction later, such as by selecting a “transact later” button. The transaction selected can be performed after a predetermined amount of time has passed, or the transaction information can be stored, preferably in a central location, to allow the user to finish the transaction at a later time. The user can simply access the stored transaction information to complete the transaction.

The transaction can be delayed until a prespecified condition has occurred. For example, a purchase of stock can be made upon the price of the stock reaching a specified price. Ideally, the user is notified that the condition has occurred and is allowed to approve, amend or cancel the transaction. Otherwise the user can specify that the transaction proceed automatically without any further input from the user.

According to a preferred embodiment of the present invention, users' personal information is maintained at a location remote from the user. It should be noted that an implementor of the present invention may have several such locations. In addition, patterns of how transactions are conducted on different websites are maintained, i.e. for each unique website, all the details of how a transaction is conducted are known including the sequence of data, web pages and actions required. When the user goes to a site and say, buys something, then the name of the site and the particular page that he is conducting the transaction from, and all product identifiers that uniquely specify what he is buying from that website are sent to servers. The present invention then preferably re-creates the transaction from scratch for that particular user, website and product by using the user's stored personal information, the name of the site the transaction is being conducted from and the specific product identifiers. Once a transaction pattern is known for a site, then any user can transact on that account. Transaction patterns are not user specific, they describe how any user can conduct a transaction on a site.

The patterns for sites are collected automatically using an “account aggregation tool”. This tool can be used by anyone. The tool looks like a browser within which webpages can be opened. A person using the tool goes to a website whose pattern he needs to collect. He goes to the appropriate pages and enters the required information. The tool records all the relevant information input by the user and sent by the browser. By aggregating all the required information, the pages from where it is sent and the way it is sent, a “pattern,” or “transaction macro,” is established for conducting a transaction on the site. It should be noted that, as an alternative to direct user interaction, the account aggregation tool can utilize software that performs the actions described above, such as entering information for a purchase or sale. More information about recording and playing back patterns and transaction macros is found in copending Provisional U.S. patent application entitled SYSTEM, METHOD AND COMPUTER PROGRAM PRODUCT FOR THE RECORIDNG AND PLAYBACK OF TRANSACTION MACROS, filed Apr. 12, 2001 under Ser. No. 60/283,781, and which is incorporated herein by reference for all purposes.

Once a pattern is established for a site, users can transact from it. The way an illustrative transaction then occurs is as follows. A user goes to the site he wishes to transact from and selects the product he wishes to buy. On the device that the user is conducting the transaction from, he presses a “buy now” button. The user is then immediately notified that the transaction has been received and will be conducted on his behalf. Once the user presses the button, servers receive the information about the site and the product that the user wished to transact from. Using the user's personal information stored on a database, and the transaction pattern for that site, the transaction is conducted on behalf of the user. If the user wished to transact anonymously, the appropriate amount are first deducted from the user's account and the transaction is conducted on behalf of the user using its own financial information. Once the transaction is successful, the user is notified and the product is shipped to the user's address. In case the transaction pattern for the site is not available or nonexistent, an alert is sent to a person or a program within the organization that is implementing the present invention, which, using the account aggregation tool goes to the site and records the transaction pattern for the site. As an option, in case the item that the user has requested cannot be found, the item is purchased for the user from another site.

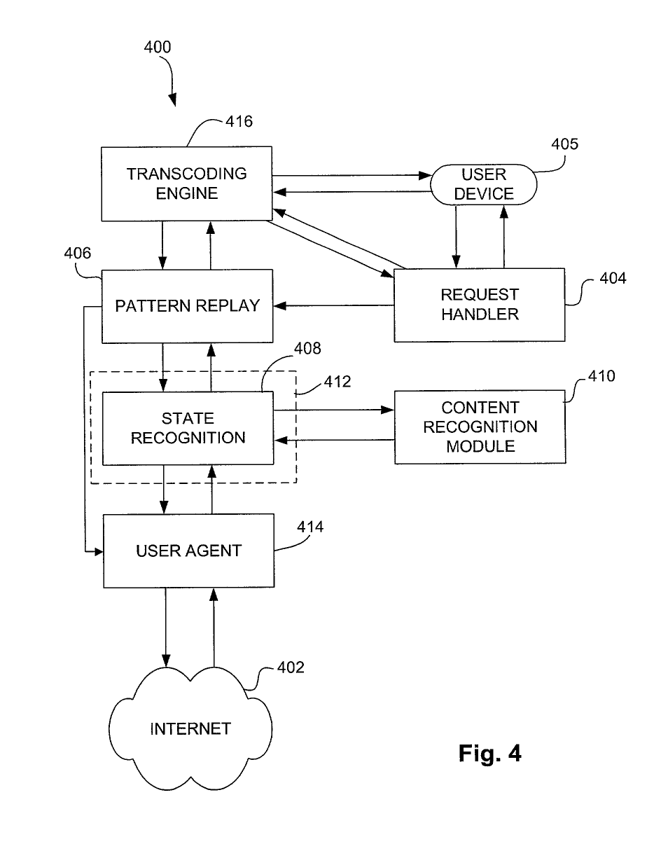

FIG. 4 illustrates an exemplary system 400 for navigating a network 402, including conducting transactions, in accordance with one embodiment of the present invention.

A Request Handler (RH) 404 communicates with a user device 405. The RH manages requests from the user device, routing them to the appropriate system component.

When a user requests a transaction, the request is sent to a Pattern Replay Engine (PRE) 406, which replays a pattern for conducting a transaction on behalf of a user.

The State Recognition Module (SRM) 408 determines which state a website is in based on its current output, such as a structure of the current output. The SRM may also communicate with a Content Recognition Module 410, which recognizes states based on the actual content of the output of a website rather than the structure of the output. A Connector 412 is in communication with the SRM. The Connector executes a state in the pattern.

The User Agent 414 is used by other components of the system to provide the actual interaction with a remote website. For example, when replaying a pattern, the SRM communicates with the User Agent via the Connector to provide instructions to the User Agent. The other system components have intelligence built into them that instructs them how to utilize the User Agent. For example, when a user clicks on a button on a page, other components instruct the User Agent to navigate to the desired web page and perform some action, such as filling in a form. The User Agent retrieves the resulting page and returns it to the other components.

A Transcoding Page Rending Engine (TRE) a416 renders content for display on the user device. Preferably, the TRE is able to render content on any display environment.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. A method for conducting a transaction on a website without requiring a user to submit personal information, comprising the steps of:
(a) storing information about a user in a database located remotely from the user;
(b) receiving a request from the user for purchase of at least one of a product and a service on a website;
(c) retrieving a purchase pattern of the website; and
(d) purchasing the at least one of the product and service on the website based on the purchase pattern.

2. A method as recited in claim 1, wherein the purchase pattern includes a sequence of data required, identification of web pages presented, and actions required during a purchase transaction.

3. A method as recited in claim 1, further including the steps of determining an identification of the website and determining an identifier of the at least one of the product and service.

4. A method as recited in claim 3, wherein the step of purchasing the at least one of the product and service further includes the steps of recreating a purchase transaction on the website utilizing the user information, the identification of the website, and the identifier of the at least one of the product and service.

5. A method as recited in claim 1, wherein the step of purchasing the at least one of the product and service is performed such that the user remains anonymous.

6. A method as recited in claim 1, wherein the user makes the request from at least one of a wireless device and a hardwired device.

7. A method as recited in claim 1, wherein the user sends the request for purchase by a single selection of an item on a user interface of the user.

8. A method as recited in claim 1, wherein the request for purchase is received from the user utilizing a wireless device.

9. A method as recited in claim 1, wherein the request for purchase is received from the user utilizing a device having a physical network connection.

10. A computer program product embodied on a computer readable medium for conducting a transaction on a website without requiring a user to submit personal information, comprising:
(a) a code segment that stores information about a user in a database located remotely from the user;
(b) a code segment that receives a request from the user for purchase of at least one of a product and a service on a website;
(c) a code segment that retrieves a purchase pattern of the website; and
(d) a code segment that purchases the at least one of the product and service on the website based on the purchase pattern.

11. A computer program product as recited in claim 10, wherein the purchase pattern includes a sequence of data required, identification of web pages presented, and actions required during a purchase transaction.

12. A computer program product as recited in claim 10, further including a code segment that determines an identification of the website and a code segment that determines an identifier of the at least one of the product and service.

13. A computer program product as recited in claim 12, wherein the code segment that purchases the at least one of the product and service further includes a code segment that recreates a purchase transaction on the website utilizing the user information, the identification of the website, and the identifier of the at least one of the product and service.

14. A computer program product as recited in claim 10, wherein the code segment that purchases the at least one of the product and service performs the purchase such that the user remains anonymous.

15. A computer program product as recited in claim 10, wherein the user makes the request from at least one of a wireless device and a hardwired device.

16. A computer program product as recited in claim 10, wherein the user sends the request for purchase by a single selection of an item on a user interface of the user.

17. A computer program product as recited in claim 10, wherein the request for purchase is received from the user utilizing a wireless device.

18. A computer program product as recited in claim 10, wherein the request for purchase is received from the user utilizing a device having a physical network connection.

19. A system for conducting a transaction on a website without requiring a user to submit personal information, comprising:
(a) logic that stores information about a user in a database located remotely from the user;
(b) logic that receives a request from the user for purchase of at least one of a product and a service on a website;
(c) logic that retrieves a purchase pattern of the website; and
(d) logic that purchases the at least one of the product and service on the website based on the purchase pattern.

20. A system as recited in claim 19, wherein the purchase pattern includes a sequence of data required, identification of web pages presented, and actions required during a purchase transaction.

21. A system as recited in claim 19, further including logic that determines an identification of the website and logic that determines an identifier of the at least one of the product and service.

22. A system as recited in claim 21, wherein the logic that purchases the at least one of the product and service further includes logic that recreates a purchase transaction on the website utilizing the user information, the identification of the website, and the identifier of the at least one of the product and service.

23. A system as recited in claim 19, wherein the logic that purchases the at least one of the product and service performs the purchase such that the user remains anonymous.

24. A system as recited in claim 19, wherein the user makes the request from at least one of a wireless device and a hardwired device.

25. A system as recited in claim 19, wherein the user sends the request for purchase by a single selection of an item on a user interface of the user.

26. A system as recited in claim 19, wherein the request for purchase is received from the user utilizing a wireless device.

27. A system as recited in claim 19, wherein the request for purchase is received from the user utilizing a device having a physical network connection.

28. A method for an account aggregation tool for determining a transaction pattern of a website, comprising the steps of:
(a) identifying a website;
(b) determining types of user information required on a user information page for purchase of at least one of a product and a service;
(c) identifying the user information page;
(d) associating the types of information required with fields of the information page; and
(e) storing the types of information, an identification of the information page, and the associations of the types of information and the fields.

29. A method as recited in claim 28, wherein a manner in which the user information is sent to the website is also recorded.

30. A method as recited in claim 28, wherein the request for purchase is received from the user utilizing a wireless device.

31. A method as recited in claim 28, wherein the request for purchase is received from the user utilizing a device having a physical network connection.
